(19) United States
(12) Patent Application Publication
(10) Pub. No.: US 2004/0158535 A1
(43) Pub. Date: Aug. 12, 2004

(54) Automated method and apparatus for aiding convergence in negotiation

(76) Inventors: Claudio Bartolini, Menlo Park, CA (US); Christopher William Preist, Montpellier Bristol (GB); Andrew Robert Byde, Mintpellier Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/473,608

(22) PCT Filed: Apr. 11, 2002
(86) PCT No.: PCT/GB02/01680

(30) Foreign Application Priority Data
Apr. 11, 2001 (GB) 0109072.9
Jul. 31, 2001 (GB) 01118672.5

(51) Int. Cl. G06F 17/60

(52) U.S. Cl. 705/80

(57) ABSTRACT

A computerised method for measuring compatibility among negotiation proposals of participants which communicate using an electronic communications network comprises the steps of: submitting proposals to a centralised negotiation processor from the participants; returning information on compatible or near-compatible proposals to each participant from a centralised negotiation processor; locally measuring compatibility of the returned proposals based on the participant's preferences over the parameters being negotiated using a local compatibility measurer; and ranking the returned proposals based on the local measurements of compatibility of the proposals.

The present invention relates to a method and apparatus for automated multi-party multivariate negotiation, in particular, for automated multi-party multivariate negotiation that optimises the process of matching negotiation proposals while preserving the confidentiality of the participants' preferences.

The growth of electronic based trade and the explosion in electronic commerce (e-commerce) has spawned the development of automated trading systems in which each user delegates authority over some trade-related decisions to an automated agent implemented in software. The agents interact using an agreed protocol to further the user's interests, which is their main function. For example, in the context of a commercial transaction where a user wishes to by an airline ticket, the user may employ an agent which interacts with other agents employed by travel agents using a negotiation protocol to obtain the cheapest ticket fare for the customer's selected destination.

Improvements in communication systems and the accompanying increase in bandwidth has enabled transactions to take place far more frequently, quickly and cheaply than before. Market conditions are constantly changing making it difficult for human users to react fast enough to negotiate in response to the fluctuating market conditions. These factors have contributed to the increase in the use of automated transaction/negotiation systems.

The negotiation process can be described as an exchange of negotiation proposals among the participants to the negotiation itself. A negotiation proposal consists of an assignment of values to a pre-agreed set of variable attributes of the object of negotiation. Values assigned to the attributes can either be point values (e.g. price=200, color=green) or constraints expressing a range of possible values (e.g. price<350, color=red OR blue). Proposal might even associate meta-values to attributes such as don't-care, not-admissable etc.

Every time a new proposal is submitted, it has to be checked against pre-existing valid proposals for compatibility. Two negotiation proposals are compatible if they present compatible assignments or constraints over the variable attributes of the object of negotiation.

In case two proposals are not compatible, it is in the interest of the negotiating parties to have information returned so as to know what the exact points of disagreement are between the proposals. Clear information on the disagreement is needed to help convergence of the negotiation process.

Existing proposal compatibility checkers function like the one described in International Patent Application, Publication No. WO 98/41942 (Optimark). Optimark discloses a method and apparatus for automating negotiations between parties. The checker disclosed by Optimark determines compatibility among proposals and moves straight away to form an agreement among compatible proposals.

If there are not any compatible proposals, nothing is returned to the participant leaving the participant with no information on how best to tune their existing proposals so as to converge to an agreement, if possible.

Conversely, if a direct measure of the participant's preferences is given away, then the participant's counter-part may take advantage of knowing this information to tune their existing proposals to obtain maximum benefit at the cost of the participant. The invention seeks to address the above-mentioned problems.

According to a first aspect of the invention, there is provided a computerised method for measuring compatibility among negotiation proposals of participants which communicate using an electronic communications network, said method comprising: submitting proposals from the participants to a centralised negotiation processor via said electronic communications network; for each proposal, said centralised negotiation processor returning to the participant who submitted that proposal information on compatible or near-compatible proposals; the participant locally measuring compatibility of the returned proposals based on the participant's preferences over the parameters being negotiated using a local compatibility measurer; and ranking the returned proposals based on the local measurements of compatibility of the proposals.

According to a second aspect of the invention there is provided a computerised method for measuring compatibility among negotiation proposals of participants which communicate using an electronic communications network, said method comprising: submitting proposals from the participants to a centralised negotiation processor via said electronic communications network; for each proposal, said centralised negotiation processor returning to the participant who submitted that proposal information on compatible or near-compatible proposals; the participant locally measuring compatibility of the returned proposals based on the participant's preferences over the parameters being negotiated using a local compatibility measurer; ranking the returned proposals based on the local measurements of compatibility of the proposals that include factors not provided in the proposal as submitted; and determining a best possible matching of proposals based on the ranked list of returned proposals.

According to a third aspect there is provided a computerised method for measuring compatibility among negotiation proposals of participants which communicate using an electronic communications network, said method comprising: submitting proposals from the participants to a centralised negotiation processor via said electronic communications network, whereby said centralised negotiation processor comprises a centralised compatibility checker for receiving said proposals from said participants; for each proposal, said centralised compatibility checker returning to the participant who submitted that proposal information on compatible or near-compatible proposals; the participant locally measuring compatibility of the returned proposals based on the participant's preferences over the parameters being negotiated using a local compatibility measurer; and ranking the returned proposals based on the local measurements of compatibility of the proposals.

According to a fourth aspect there is provided apparatus for measuring compatibility among negotiation proposals, comprising: a plurality of participants configured to issue negotiation proposals, each participant comprising an input data port and an output data port; a centralised negotiation processor for returning compatible or near-compatible proposals to the participants; an input data port coupled to said centralised negotiation processor; and an output data port coupled to said centralised negotiation processor; said centralised negotiation processor being in communication with said participants across an electronic communications network between the respective input data ports and output data ports of the participants and itself; each participant comprising, a local compatibility measurer for measuring compatibility of the returned proposals on the basis of the participant's preferences over the parameters being negotiated, said local compatibility measurer configured so as to rank the returned proposals on the basis of the local measurements of compatibility.

According to a fifth aspect there is provided apparatus for measuring compatibility among negotiation proposals, comprising: a plurality of participants configured to issue negotiation proposals, each participant comprising an input data port and an output data port; a centralised negotiation processor comprising a centralised compatibility checker for returning compatible or near-compatible proposals to the participants; an input data port coupled to said centralised negotiation processor; and an output data port coupled to said centralised negotiation processor; said centralised negotiation processor being in communication with said participants across an electronic communications network between the respective input data ports and output data ports of the participants and itself; each participant comprising, a local compatibility measurer for measuring compatibility of the returned proposals on the basis of the participant's preferences over the parameters being negotiated, said local compatibility measurer configured so as to rank the returned proposals on the basis of the local measurements of compatibility.

According to a sixth aspect there is provided a participant client for issuing negotiation proposals in a convergence aided negotiation system comprising a centralised negotiation processor, said client comprising: an input data port for receiving compatible or near-compatible proposals from said centralised negotiation processor; an output data port for submitting negotiation proposals to said centralised negotiation processor; a local compatibility measurer for measuring compatibility of said received proposals from said centralised negotiation processor on the basis of the participant's preferences over the parameters being negotiated, said local compatibility measurer configured so as to rank the received proposals on the basis of the local measurements of compatibility.

According to a seventh aspect there is provided a Preference Map for measuring compatibility among negotiation proposals according to the first or second aspect.

According to a eighth aspect there is provided a centralised negotiation engine for aiding convergence in a negotiation system comprising participants for measuring the compatibility of compatible and near-compatible proposals and determining a best possible matching of proposals based on the measurements of compatibility, said engine comprising: an input data port for receiving negotiation proposals from the participant clients; an output data port for returning compatible or near-compatible negotiation proposals to said participants; said engine being in communication with said participants across an electronic communications network between the respective input data ports and output data ports of the participants and itself, and configured so as to form agreements from the returned best possible matching of proposals from said participants.

A specific embodiment of the invention will now be described, by way of example only, with reference to the accompanying drawing in which:

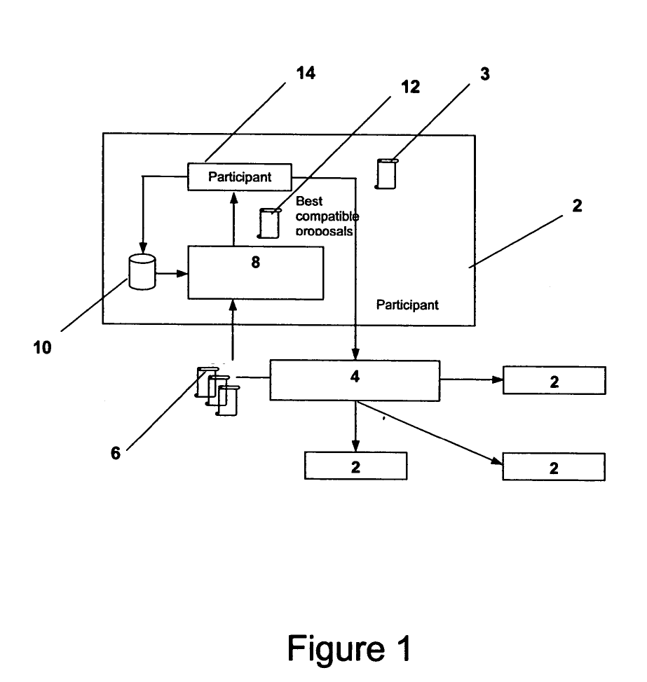

FIG. 1 shows a block diagram of an embodiment according to the invention.

The applicant's copending British Patent Application of even date entitled “Method and Apparatus for Automated Multi-Party Multivariate Negotiation” is incorporated herein by reference, and provides a general infrastructure for the present automated convergence in negotiation method and apparatus—this is described further in the Appendix. Moreover, the terminology established in the co-pending application will be relied upon as needed. The following description will detail the flow of the novel features of the preferred embodiments of the present method and apparatus for an automated system method and apparatus for aiding convergence in negotiation.

With reference to FIG. 1 a number of participants 2 are in communication, via an electronic communications network, to a centralised compatibility checker 4 forming part of a centralised negotiator (not shown).

Each participant 2 once admitted to the negotiation through an admission process, submits a negotiation proposal 3 to the centralised compatibility checker 4 of the centralised negotiator. A set of compatible proposals and near-compatible proposals is computed centrally using the centralised compatibility checker 4, and each participant 2 is notified of all the compatible and near-compatible proposals 6 to the proposal 3 they have submitted.

A local compatibility measurer assesses the compatibility of the notified proposals based on the participant's preferences stored in the form of a Preference Map on a local database 10. On the basis of this local assessment the proposals are then ranked and an ordered list is returned to the user participant.

This technique does not require the participants to give away private information on the utility that they associate to a particular assignment of values to an attribute. The set of compatible proposals is computed centrally, but the relative score of compatible proposals is evaluated locally, according to the participant's preferences. At this point, a decision can be made on whether to accept an existing proposal by a counterpart or to close the gap between a previously submitted proposal by a participant and an existing proposal by a counterpart i.e. a near-compatible proposal. In this case, all the elements that drive the decision are present locally and do not need to be given away by the participant to a central compatibility-checking engine.

In the example started above, the participant will submit a proposal that simply says color=red OR blue, without giving away the fact that it prefers red over blue. This is because this information could be used by its counterparts to tune their proposals so as to make the most out of them. When the central proposal compatibility checking engine signals to the participant that there are proposals that match it, the local compatibility measurer 8 will attach a superior score to the compatible proposals stating color=red than the score that is attached to the compatible proposals stating color=blue. Matching proposals will therefore be ranked according to the preference of the participant, so to drive the decision on what among compatible proposals will be the one chosen.

Thus it is possible to separate objective proposal compatibility checking from subjective proposal fitness measuring based on preferences. This is reflected in the proposed architecture to implement the invention.

Each of the participants 2 will submit proposals 3 (not decorated by expressions of preferences) to the central compatibility-checking engine 4. A participant 2 can be associated to a module that acts as a private proposal evaluator 8. Given an outstanding proposal that has been submitted by one of the counterparts, the local compatibility measurer engine 8, will rank it against competing proposals, based on user's preferences.

Although the invention has been shown and described with respect to a best mode embodiment thereof, it should be understood by those skilled in the art that the foregoing and various other changes, omissions and additions in the form and detail thereof made therein without departing from the scope of the invention as claimed.

### APPENDIX

There is described an automated method and apparatus for embedding a market mechanism that can maximize the global utility of all the participants in a multi-party negotiation process over multiple parameters, and does not require the participants to publish their preferences and, therefore, give away important confidential information to that could be used by other participants in the negotiation process.

Accordingly, the participant keeps its preferences secret by providing a relative score of the competing compatible proposals. To illustrate this the example used above is continued. Suppose a participant has the following preferences:

Color: red—score: 90

Color: blue—score: 60

Price: x—Score: (500−x)

The participant will give the proposal P1 (proposal type=sell, item=shoes, price=330, color=red) a score of 90+(500−330)=260

The participant will give the proposal P2 (proposal type=sell, item=shoes, price=320, color=blue), a score of 60+(500−320)=240

Normalizing the scores, the participant will rate the proposal P1 as 52% and the proposal P2 as 48%. This is all the information that the participant has to give away. In processes where the participant gives away its preferences, that information may be tailored by the seller/auctioneer to extract as much value from the participant as possible, by selling the red shoes up to 350, a price at which the participant will still prefer red shoes over blue ones.

Thus the invention herein described can maximize the global utility of all the participants in a multi-party negotiation process over multiple parameters, but does not require the participants to give away private information on the utility that they associate to a particular assignment of values to an attribute.

A further example will be explained to help in clarifying the proposed implementation, with reference to FIG. 1

After going through an admission process, each of the participants 4 to negotiation will submit proposals 22 that do not contain any expressions of preferences to a central compatibility checking engine 8 forming part of a central negotiator 6. In this second example the participants are three buyers B1, B2 and B3 and two sellers S1 and S2. The sellers submit proposals PB1, PB2, PB3, PS1 and PS2.

A set of compatible proposals is computed centrally using the centralised compatibility checking engine 8 and each participant 4 is notified of all the compatible proposals 10 to the one they have submitted. In this second example, it is assumed for simplicity that all of the sellers' proposals are compatible with all the buyers' proposals. So then each of the buyers receives notification of PS1 and PS2, and each of the sellers receives notification of PB1, PB2 and PB3.

Next, the participants 4 who submitted proposals 22 assign a relative score to competing compatible proposals 10 according to preferences stored in a local preferences' database 12 using a local module that acts as a private proposal evaluator 14. Given an outstanding proposal that has been submitted by one of the participant's counterparts, the local private proposal evaluator 14 will rank it against competing proposals based on the participant's preferences and assign relative scores to the compatible proposals. In this example, the scores are assigned as in the following Table A:

| | PB1 | PB2 | PB3 | PS1 | PS2 |
|---|---|---|---|---|---|
| B1 | | | | 52 | 48 |
| B2 | | | | 46 | 54 |
| B3 | | | | 59 | 41 |
| S1 | 32 | 38 | 30 | | |
| S2 | 39 | 31 | 40 | | |

From hereon there are two ways in which the best possible matching of compatible proposals is carried out.

In the first way, the relative scores 18 assigned to competing compatible proposals are then sent to a best assignment computation module 16 forming part of the central negotiator 6. The computation module 16 computes the best possible matching of proposals with respect to the relative score that each participant has declared.

To compute the best assignment, the following simplified table B can be computed, where for each entry B(Si,Bj), the weighted sum of A(Si,PBj) and A(Bj,PSi) is copied. A fair distribution of weights would take into account how many competing proposals there are on each side. In this example, to give the sellers an equal discrimination power as the buyers have, the sellers preferences should be weighed as 3/2 the buyers preferences.

In general it would write be written:

B(Si,Bj)=n*A(Si,PBj)+m*(Bj,PSi)

The weights could be skewed to give more relative importance to the buyers or sellers preferences if needed. A skewing factor can be introduced with a couple of integers ks, kb, and by defining the sellers skewing factor as ks/(ks+kb) and the buyers skewing factor as kb/(ks+kb). The formula becomes:

B(Si,Bj)=[ks/(ks+kb)]*n*A(Si,PBj)=[kb/(ks+kb)]*m*A(bj,PSi)

In this example, assuming ks=kb=1 (i.e. fair treatment of preferences of sellers and buyer), for the entry (B(S1,B1):

B(S1,B1)=3*A(S1,PB1)+2*A(B1,PS1)=3*32+2*52=96+104=200

Completing the table B, it would look as follows:

| | B1 | B2 | B3 |
|---|---|---|---|
| S1 | 200 | 206 | 208 |
| S2 | 183 | 201 | 202 |

The problem to solve now, is to find an assignment of each of the sellers to one buyer under the constraint that a buyer can be assigned to at most one seller, while maximizing the global utility. In the dual case, where the buyers outnumber the sellers, we would assign each buyer to one seller. The problem is equivalent to the maximised version of the Generalized Assignment Problem (GAP), from operations research, and can be formulated as follows:

Let there be m selling proposals submitted by the sellers S1 . . . Sm

Let there be n buying proposals submitted by the buyers B1 . . . Bn

Assume m<=n (or switch sellers with buyers if that is not true)

Let xij=1 when Si is assigned to Bj, in a possible solution of the generalized assignment problem; 0 otherwise

Let uij=the entry (Si,Bj) in the table we just computed. That is given by the relative score that Bj assigns to the proposal PSi plus the relative score that Si assigns to the proposal PBj.

The problem is now:

max S(i=1 . . . m; S(j=1 . . . n; xij*uji)

s.t. for each j=1 . . . n, S(i=1 . . . m; xij)<=1 (each j is assigned to exactly one i)

for each i=1 . . . m, S(j−=1 . . . n; xij)=1 (each i is assigned to exactly one j)

where S(i=1 . . . m(i) means the sum for l equals 1 to m of the quantities f(i)

The best assignment of selling proposals to buying proposals can be computed by applying well known algorithms for the solution of the generalized assignment problem.

In this example, the best assignment is then S1−B3 and S2−B2, for a global utility of 208+201=409.

Notice that B1's request will remain unsatisfied, and both S1 and S2 will not be assigned to their first choice.

In the second way aggregate scores are computer for each proposal from Table A, as follows:

| | B1 | B2 | B3 |
|---|---|---|---|
| S1 | 84 | 84 | 89 |
| S2 | 77 | 85 | 81 |

The problem to solve now, is to find an assignment of each of the sellers to each of the buyers, under the constraint that a buyer can be assigned to at most one seller and vice versa, while maximizing the global utility.

The problem is equivalent to the maximised version of the Assignment Problem (AP), from operations research, and can be formulated as follows:

Let there be n selling proposals submitted by the sellers S1 . . . Sn and n buying proposals submitted by the buyers B1 . . . Bn

Let xij=1 when Si is assigned to Bj, in a possible solution of the assignment problem; 0 otherwise

Let uij=the entry (Si, Bj) in the table above just computed. This is given by the relative score that Bj assigns to the proposal PSi plus the relative score that Si assigns to the proposal PBj.

The problem is now:

max S(l=1 . . . m; S(j=1 . . . n; xij*uij)

s.t. for each j=1 . . . n, S(l=1 . . . m;xij)=1 (each j is assigned to exactly one i)

for each i=1 . . . m, S(j−=1 . . . n; xij)=1 (each i is assigned to exactly one j)

where S(l=1 . . . m f(i)) means the sum for i equals 1 to m of the quantities f(i)

The best assignment of selling proposals to buying proposals can be computed by applying well known algorithms for the solution of the assignment problem.

In this example, the best assignment is then S1−B3 and S2−B2, for a global utility of 89=85=174.

Notice that B1's request will remain unsatisfied, and both S1 and S2 will not be assigned to their first choice.

Once the best possible assignment of compatible proposals is completed, the best assignment computation module will notify the participants of the formed agreement 20.

Both of the different techniques described above return the same assignment in the example presented. Though with the computation presented in the first alternative some weak proposals might be rewarded as it would be in the case that—everything else remaining the same—the rating of B1 of the seller proposals would be:

| | PB1 | PB2 | PB3 | PS1 | PS2 |
|---|---|---|---|---|---|
| B1 | | | | <57 | <43 |

This would increase the global utility of the assignment B1−S1. This means that the best strategy for the more populated group of traders (either buyers or sellers) would be to score one of the competing proposals very high, in the hope to maximize the global utility for that assignment. With the computation presented in the second alternative, each buyer (seller) is encouraged to be sincere in rating proposals instead.

Using the methods described above it is possible to separate objective proposal compatibility checking from subjective proposal fitness measuring based on preferences without giving the user preferences away, but by only computing a relative score for it.

The participants' preferences may also be stored in the form of a preference map on the local database for access in subsequent negotiations.

1. A computerised method for measuring compatibility among negotiation proposals of participants which communicate using an electronic communications network, said method comprising:
submitting proposals from the participants to a centralised negotiation processor via said electronic communications network;
for each proposal, said centralised negotiation processor returning to the participant who submitted that proposal information on compatible or near-compatible proposals;
the participant locally measuring compatibility of the returned proposals based on the participant's preferences over the parameters being negotiated using a local compatibility measurer; and
ranking the returned proposals based on the local measurements of compatibility of the proposals.

2. A method as claimed in claim 1, wherein in said local measurement of compatibility the participant includes factors not provided in the proposal as submitted.

3. A method according to claim 1, further comprising:
determining a best possible matching of proposals based on the ranked list of returned proposals.

4. A method according to claim 3, further comprising:
submitting details of the best possible matching of proposals to said centralised negotiation processor.

5. A method according to claim 4, further comprising:
forming agreements on the basis of the matched proposals using said centralised negotiation processor.

6. A method according to claim 1, wherein said centralised negotiation processor comprises a centralised compatibility checker for receiving proposals from the participants and for returning information on compatible or near-compatible proposals to each participant.

7. A method according to claim 6, further comprising:
analysing the proposals for compatibility using said centralised compatibility checker, prior to returning compatible or near-compatible proposals to each participant.

8. A method according to claim 5, further comprising:
notifying the participants of the formed agreements.

9. A computerised method for measuring compatibility among negotiation proposals of participants which communicate using an electronic communications network, said method comprising:
submitting proposals from the participants to a centralised negotiation processor via said electronic communications network;
for each proposal, said centralised negotiation processor returning to the participant who submitted that proposal information on compatible or near-compatible proposals;
the participant locally measuring compatibility of the returned proposals based on the participant's preferences over the parameters being negotiated using a local compatibility measurer;
ranking the returned proposals based on the local measurements of compatibility of the proposals that include factors not provided in the proposal as submitted; and
determining a best possible matching of proposals based on the ranked list of returned proposals.

10. A method according to claim 9, further comprising:
submitting details of the best possible matching of proposals to said centralised negotiation processor.

11. A method according to claim 10, further comprising:
forming agreements on the basis of the matched proposals using said centralised negotiation processor.

12. A method according to claim 9, wherein said centralised negotiation processor comprises a centralised compatibility checker for receiving proposals from the participants and for returning information on compatible or near-compatible proposals to each participant.

13. A method according to claim 12, further comprising:
analysing the proposals for compatibility using said centralised compatibility checker, prior to returning compatible or near-compatible proposals to each participant.

14. A method according to claim 11, further comprising:
notifying the participants of the formed agreements.

15. A computerised method for measuring compatibility among negotiation proposals of participants which communicate using an electronic communications network, said method comprising:
submitting proposals from the participants to a centralised negotiation processor via said electronic communications network, whereby said centralised negotiation processor comprises a centralised compatibility checker for receiving said proposals from said participants;
for each proposal, said centralised compatibility checker returning to the participant who submitted that proposal information on compatible or near-compatible proposals;
the participant locally measuring compatibility of the returned proposals based on the participant's preferences over the parameters being negotiated using a local compatibility measurer; and
ranking the returned proposals based on the local measurements of compatibility of the proposals.

16. A method according to claim 15, further comprising:
analysing the proposals for compatibility using said centralised compatibility checker, prior to returning compatible or near-compatible proposals to each participant.

17. A method according to claim 15, further comprising:
notifying the participants of the formed agreements.

18. Apparatus for measuring compatibility among negotiation proposals, comprising:
a plurality of participants configured to issue negotiation proposals, each participant comprising an input data port and an output data port;
a centralised negotiation processor for returning compatible or near-compatible proposals to the participants;
an input data port coupled to said centralised negotiation processor; and
an output data port coupled to said centralised negotiation processor;
said centralised negotiation processor being in communication with said participants across an electronic communications network between the respective input data ports and output data ports of the participants and itself;
each participant comprising, a local compatibility measurer for measuring compatibility of the returned proposals on the basis of the participant's preferences over the parameters being negotiated, said local compatibility measurer configured so as to rank the returned proposals on the basis of the local measurements of compatibility.

19. An apparatus according to claim 18, wherein each participant further comprises a local database holding information of the participant's preferences, and which is accessible to said local compatibility measurer for measuring the compatibility of the returned proposals.

20. An apparatus according to claim 19, wherein the information of the participant's preferences is stored as data in a Preference Map in said local database.

21. An apparatus according to claim 18, wherein said centralised negotiation processor comprises a centralised compatibility checker for returning compatible or near-compatible proposals.

22. Apparatus for measuring compatibility among negotiation proposals, comprising:
a plurality of participants configured to issue negotiation proposals, each participant comprising an input data port and an output data port;
a centralised negotiation processor comprising a centralised compatibility checker for returning compatible or near-compatible proposals to the participants;
an input data port coupled to said centralised negotiation processor; and
an output data port coupled to said centralised negotiation processor;
said centralised negotiation processor being in communication with said participants across an electronic communications network between the respective input data ports and output data ports of the participants and itself;
each participant comprising, a local compatibility measurer for measuring compatibility of the returned proposals on the basis of the participant's preferences over the parameters being negotiated, said local compatibility measurer configured so as to rank the returned proposals on the basis of the local measurements of compatibility.

23. An apparatus according to claim 22, wherein each participant further comprises a local database holding information of the participant's preferences, and which is accessible to said local compatibility measurer for measuring the compatibility of the returned proposals.

24. An apparatus according to claim 23, wherein the information of the participant's preferences is stored as data in a Preference Map in said local database.

25. A participant client for issuing negotiation proposals in a convergence aided negotiation system comprising a centralised negotiation processor, said client comprising:
an input data port for receiving compatible or near-compatible proposals from said centralised negotiation processor;
an output data port for submitting negotiation proposals to said centralised negotiation processor;
a local compatibility measurer for measuring compatibility of said received proposals from said centralised negotiation processor on the basis of the participant's preferences over the parameters being negotiated, said local compatibility measurer configured so as to rank the received proposals on the basis of the local measurements of compatibility.

26. A participant client according to claim 25, further comprising a local database for holding information of the participant's preferences, and which is accessible to said local compatibility measurer for measuring the compatibility of said received proposals.

27. A participant client according to claim 26, wherein the information of the participant's preferences is stored as data in a Preference Map in said local database.

28. A Preference Map for measuring compatibility among negotiation proposals as described in claim 11.

29. A Preference Map for measuring compatibility among negotiation proposals as described in claim 20.

30. A centralised negotiation engine for aiding convergence in a negotiation system comprising participants for measuring the compatibility of compatible and near-compatible proposals and determining a best possible matching of proposals based on the measurements of compatibility, said engine comprising:
an input data port for receiving negotiation proposals from the participant clients;
an output data port for returning compatible or near-compatible negotiation proposals to said participants;
said engine being in communication with said participants across an electronic communications network between the respective input data ports and output data ports of the participants and itself, and configured so as to form agreements from the returned best possible matching of proposals from said participants.

31. A centralised negotiation engine according to claim 30, comprising a centralised compatibility checker for returning compatible and near-compatible proposals to said participants.
